(19) United States
(12) Patent Application Publication
(10) Pub. No.: US 2012/0177883 A1
(43) Pub. Date: Jul. 12, 2012

(54) Artificial Stone Laminate

(76) Inventor: Gosakan Aravamudan, Bangalore (IN)

(21) Appl. No.: 13/497,054

(22) PCT Filed: Sep. 20, 2010
(86) PCT No.: PCT/IN10/00630

§ 371 Date: Mar. 20, 2012

(30) Foreign Application Priority Data
Sep. 22, 2009 (IN) 2297/CHE/2009

(51) Int. Cl. B32B 3/00; B05D 5/00; B05D 3/12

(52) U.S. Cl. 428/143; 427/600

(57) ABSTRACT

An artificial stone laminate comprising a top single layer of particulates of substantially a single size, a rear layer of reinforcing fibers, and a binder is provided. The single size of the particulates is between 0.5 mm and 3 mm. Each of the particulates has an exposed top flat surface section area that is substantially the largest sectional area that can be exposed in the particulates. A single layer of particulates of uniform size is spread on a release surface. The single layer of particulates is vibrated whereby the particulates are packed closely, touch one another adjacently in a horizontal plane, and achieve high surface coverage. The layer of reinforcing fibers is placed on the single layer of particulates. A binder is deposited for filling the gaps between the particulates and bonding the reinforcing fibers to the particulates. After the binder cures, the surface of the single layer of particulates is polished.

### CROSS REFERENCE TO RELATED APPLICATIONS

This application claims the benefit of the following patent applications:
1. Provisional patent application number 2297/CHE/2009 titled “Quartz Composite” filed on 22 Sep. 2009 in the Indian Patent Office.
2. PCT application number PCT/1N2010/000630 titled “Artificial Stone Laminate” filed on 20 Sep. 2010 in the Indian Patent Office.

The specifications of the above referenced patent applications are incorporated herein by reference in their entirety.

### BACKGROUND

This invention, in general, relates to building structures. More particularly, this invention relates to an architectural surface for furniture and building structures.

Currently, decorative laminates and wood veneers are extensively used as architectural surfaces. In most cases, decorative laminates are manufactured from kraft paper impregnated with phenolic resin. Wood and its derivatives are currently the preferred choice of material for surfacing furniture and building structures. Wood veneers and wood derived products such as laminates place a large burden on our already shrinking environmental resources.

Decorative laminates show scratches over prolonged use, and uncoated wood veneers absorb moisture and stain easily. If not properly taken care of, wood products have a limited life. Wood products may decay when exposed to moisture for long periods, and are prone to termite attack. In tropical countries with excess rainfall, wood expands seasonally due to excess moisture content. As a result, doors and windows surfaced with wood or its derivatives get jammed within their frames.

Engineered stone is currently manufactured in various thicknesses, for example, of thickness 12 mm. Such engineered stone is not currently used as a thin architectural surface laminate, for example, in laminate applications such as surfacing on wooden boards. Architectural laminates need to be of a thickness of approximately 1 mm to 2 mm. For aesthetic reasons, as well as for the purpose of improved scratch resistance of the architectural surface, it is necessary to maximize the surface area of the exposed and polished quartz particles. However, in the currently available engineered stone, such a maximization of the exposed quartz area is not achieved, and the thickness on the order of 1.5 mm has also not been achieved. The particle distribution and surface area characteristics of such engineered stone is illustrated in FIG. 1A, FIG. 1B, and FIG. 1C. FIG. 1A exemplarily illustrates a sectional view of an engineered stone composite prepared from particles stacked haphazardly one above the other. The thickness of the engineered stone increases as a result of this haphazard stacking of particles on top of one another. FIG. 1B exemplarily illustrates a top view of the engineered stone composite prepared from particles stacked haphazardly one above the other. If the top surface of the polished engineered stone is viewed, the surface area of the polished quartz particulates is not optimized to be at a maximum level. A significant area of the exposed engineered stone surface is covered with its binder matrix. FIG. 1C exemplarily illustrates deposition of particles of multiple sizes. The deposition of particles of multiple sizes will not allow the maximization of the exposed quartz area as the polishing process will not expose the maximum sectional surface area of the particles in the horizontal plane.

Hence, there is an unmet need for architectural laminates with a quartz surface, with a maximum exposed quartz surface area, and wherein the total thickness of the architectural laminate is approximately 1 mm to 2 mm. For aesthetic reasons, as well as for the purpose of improved scratch resistance of the architectural surface, there is a need for maximizing the surface area of the exposed and polished quartz particles.

There is a long felt but unresolved need for a substitute for wood and its derivatives that are strong, and provide good aesthetic value after prolonged use. Moreover, there is a need for a substitute for wood in architectural surfaces to reduce the environmental impact and address the disadvantages of utilizing wood. Furthermore, there is a need for decorative laminates that remain intact and provide good visual appearances even when exposed to moisture or other external environment conditions.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The artificial stone laminate disclosed herein overcomes the drawbacks of wood derived architectural surfaces. The artificial stone laminate disclosed herein has a very high abrasion resistance and is waterproof. Hence, the artificial stone laminate disclosed herein remains intact even with prolonged exposure to environmental conditions while retaining the aesthetic appearance for a considerable period of time.

The artificial stone laminate disclosed herein comprises a top single layer of particulates of substantially a single size, a rear layer of reinforcing fibers backing the particulates, and a binder bonding the particulates and the reinforcing fibers. The size deviation from the single size of the particulates is restricted to plus or minus 40%. The single size of the particulates is chosen between 0.5 mm and 3 mm. Each of the particulates has an exposed top flat surface section area. The exposed top flat surface section area of each of the particulates is substantially the largest sectional area that can be exposed in the particulates. The particulates are, for example, quartz particulates, or one or more of a combination of quartz particulates, metal pieces, and transparent particulates coated with metal and colored glass. The reinforcing fibers comprise, for example, glass fibers. The rear layer of the reinforcing fibers is, for example, a knitted glass fiber yarn. The binder is, for example, a polyester resin with a filler, an acrylic resin, etc.

Disclosed herein is a method of manufacturing an artificial stone laminate. The method disclosed herein comprises the following steps: A single layer of particulates of uniform size is spread on a release surface. The single layer of particulates is vibrated. The vibration of the single layer of particulates causes the particulates to be packed closely, to touch one another adjacently in a horizontal plane, and to achieve high surface coverage. A layer of reinforcing fibers is placed on the single layer of particulates. A binder is deposited on the layer of reinforcing fibers for filling gaps between the particulates and for bonding the reinforcing fibers to the particulates. In an embodiment, the binder can be deposited on the top single layer of particulates before the placement of the layer of reinforcing fibers. A surface of the single layer of particulates is polished until the substantially largest sectional area of the particulates is exposed. Furthermore, the method disclosed herein comprises application of vacuum and pressure to the deposited binder, the single layer of particulates, and the layer of reinforcing fibers during and/or after the deposition of the binder. The surface of the single layer of the particulates is modified chemically for improved adhesion with the binder.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1A (prior art) exemplarily illustrates a sectional view of an engineering stone composite prepared from particles stacked haphazardly one upon another, which teaches away from the artificial stone laminate disclosed herein.

FIG. 1B (prior art) exemplarily illustrates a top view of the engineering stone composite prepared from particles stacked haphazardly one upon another, which teaches away from the artificial stone laminate disclosed herein.

FIG. 1C (prior art) exemplarily illustrates deposition of particles of multiple sizes that teach away from the method disclosed herein.

FIG. 2A exemplarily illustrates a sectional view of an artificial stone laminate, where a single layer of adjacently packed particulates provide high surface coverage and result in a thin lightweight artificial stone laminate.

FIG. 2B exemplarily illustrates a top view of the artificial stone laminate, where the single layer of adjacently packed particulates provide high surface coverage and result in a thin lightweight artificial stone laminate.

FIG. 3 exemplarily illustrates a deposited single layer of particulates of uniform size, which when vibrated touch one another adjacently in a horizontal plane.

FIG. 4 illustrates a method of manufacturing an artificial stone laminate.

### DETAILED DESCRIPTION OF THE INVENTION

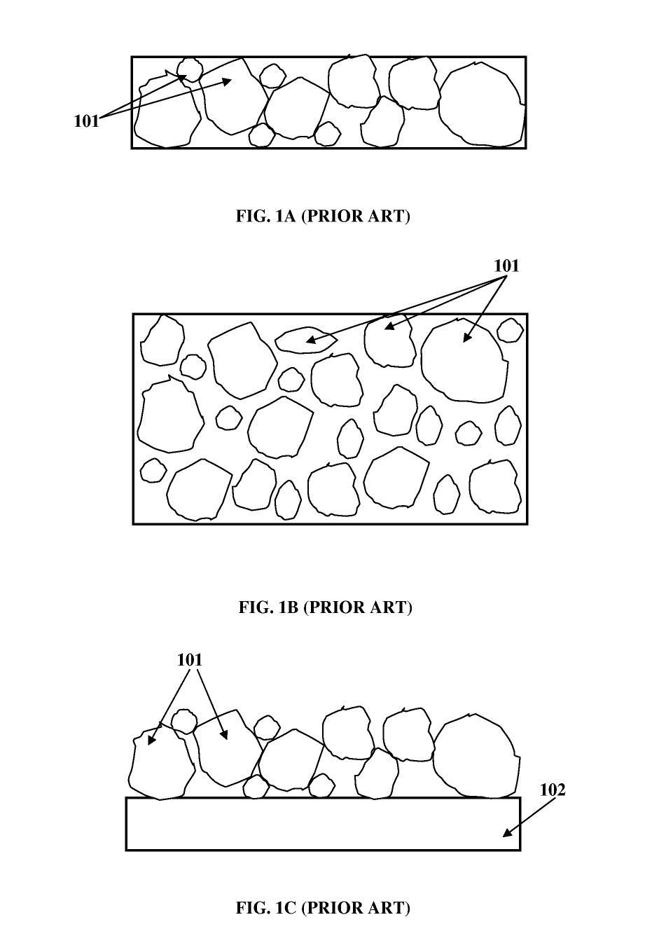

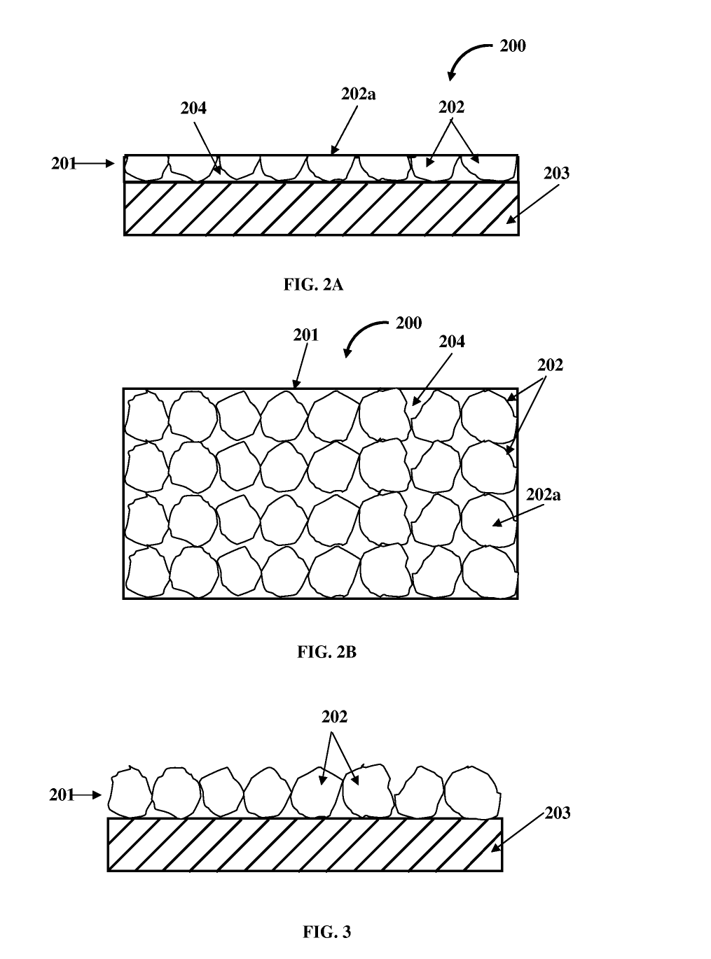

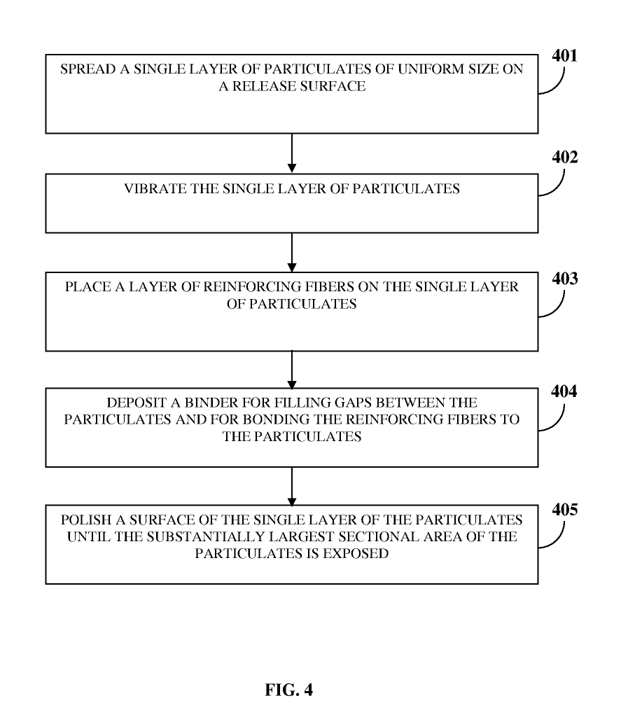

FIG. 1A and FIG. 1B exemplarily illustrate a sectional view and a top view of an engineering stone composite prepared from particles 101 stacked haphazardly one upon another, which teaches away from the artificial stone laminate 200 disclosed herein. The artificial stone laminate 200 disclosed herein is exemplarily illustrated in FIG. 2A and FIG. 2B. The particles 101 are stacked haphazardly one upon another on a release surface 102. The engineering stone composite exemplarily illustrated in FIGS. 1A-1B is used as a reference against which the advantages of the artificial stone laminate 200 disclosed herein are emphasized.

The artificial stone laminate 200 disclosed herein is, for example, a decorative laminate comprising a visually decorative and functional surface covering. Decorative laminates are required to be thin and flexible to be used as an architectural surface covering, as heavier and thicker decorative laminates pose difficulty in adhering to substrates. Thicker and heavier decorative laminates may delaminate and warp over time. The artificial stone laminate 200 disclosed herein is a single layer 201 of particulates 202 that is lightweight and visually appeasing. Furthermore, since the artificial stone laminate 200 disclosed herein requires no more than a single layer 201 of particulates 202, there is substantial reduction, for example, in cost, thickness, and weight resulting in a thin lightweight artificial stone laminate 200. The higher exposed top flat surface section area 202a of the particulates 202 of the artificial stone laminate 200 provides a greater visual decorative appeal. Furthermore, the higher exposed top flat surface section area 202a of particulates 202, for example, quartz particulates results in greater abrasion resistance and stain resistance. In contrast to the artificial stone laminate 200 disclosed herein, the particles 101 of multiple sizes, as exemplarily illustrated in FIGS. 1A-1B, make decorative laminates thicker. FIG. 1B exemplarily illustrates the relatively poor percentage surface area of particles 101 of multiple sizes exposed.

FIG. 1C exemplarily illustrates deposition of particles 101 of multiple sizes that teaches away from the method disclosed herein. FIG. 1C is used as a reference against which the advantages of the artificial stone laminate 200 disclosed herein are emphasized. If the particles 101 of multiple sizes are deposited and vibrated, the particles 101 of multiple sizes overlap and layover one another to create an uneven top surface that needs to be resin filled resulting in an unnecessary and expensive thicker laminate section.

FIGS. 2A-2B, FIG. 3, and FIG. 4 illustrate the structure and manufacturing method of the present invention, that is, the artificial stone laminate 200 disclosed herein.

FIG. 2A and FIG. 2B exemplarily illustrate a sectional view and a top view of an artificial stone laminate 200 respectively, where a single layer 201 of adjacently packed particulates 202 provide high surface coverage and result in a thin lightweight artificial stone laminate 200. The artificial stone laminate 200 disclosed herein comprises a top single layer 201 of particulates 202 of substantially a single size, a rear layer of reinforcing fibers 203 backing the particulates 202, and a binder 204 bonding the particulates 202 and the reinforcing fibers 203.

The single size of the particulates 202 is chosen between 0.5 mm and 3 mm. The preferred size of the particulates 202 is chosen, for example, in the range of about 1.05 mm to about 1.95 mm. The size deviation of the particulates 202 from the single size of the particulates 202 is restricted to plus or minus 40%. For example, within this range, a substantially single size of the particulates 202 chosen is approximately 1.5 mm. In case the chosen size of the particulates 202 is 1.5 mm, the maximum particulates 202 size ranges is plus or minus 40%, that is, the actual size of the particulates 202 is in the range of 0.9 mm to 2.1 mm. The particulates 202 are, for example, quartz particulates, or one or more of a combination of quartz particulates, metal pieces, and transparent particulates coated with metal and colored glass. The particulates 202 are preferably transparent quartz particulates. The particulates 202 further comprise, for example, metal or pigment coated quartz or glass particulates that provide improved reflective or colored aesthetics. The particulates 202 further comprise, for example, colored glass particulates that create artistic patterns or designs on the surface of the artificial stone laminate 200. All types of particulates 202 are, for example, of substantially the same size. Each of the particulates 202 has an exposed top flat surface section area 202a. The exposed top flat surface section area 202a of each of the particulates 202 is planar. The exposed top flat surface section area 202a of each of the particulates 202 is substantially the largest sectional area that can be exposed in the particulates 202.

The transparency of quartz particulates 202 gives the exposed top flat surface section area 202a of the particulates 202 a rich visual appearance. Furthermore, quartz particulates 202 provide exceptional scratch resistance. In addition to quartz particulates 202, other particulates 202 such as glass particulates or stone particulates may also be added on the exposed top flat surface section area 202a of the artificial stone laminate 200. The addition of the other particulates 202 to the quartz particulates 202 results, for example, in improved aesthetic qualities.

The reinforcing fibers 203 comprise, for example, glass fibers. The rear layer of reinforcing fibers 203 is, for example, a knitted glass fiber yarn and is preferably a glass fiber. The glass fiber may be a chopped strand matt or a knitted fiber. The glass fiber layer comprises, for example, one or more of glass fibers, polyester fibers, ceramic fibers, carbon fibers, aramid fibers, organic fibers, etc.

Consider an example where a three dimensionally knitted glass fiber yarn of thickness greater than 2 mm is overlaid on and then bonded to a layer of quartz particulates or glass particulates 202. The size of the loop of the knitted glass fiber yarn may be greater than the size of the quartz particulates 202 or the glass particulates 202. The coarse surface of the knitted glass fiber layer as well as the cavities between the knits allow for exceptional adhesion between the knitted glass fiber layer and the quartz particulates 202.

In an embodiment, a lightweight core can be provided as a backing to the layer of reinforcing fibers 203. Examples of the lightweight core are polyurethane foam, a honeycomb structure, wood, etc. The honeycomb is, for example, a paper honeycomb, a reinforced plastic honeycomb, a plastic honeycomb, an aluminum honeycomb, etc.

The binder 204 is, for example, a polyester resin with a filler, an acrylic resin, etc. The binder 204 used for filling gaps between the particulates 202 and for bonding the reinforcing fibers 203 to the particulates 202 is, for example, a thermoset plastic such as a polyester resin, along with a filler. An example of a polyester resin is a combination of 80% ortho neo pentyl glycol and 20% styrene. Another example of a polyester resin is a combination of isophthalic neo pentyl glycol, methyl methyl acrylate, and styrene. Room temperature catalysts such as methyl ethyl ketone peroxide (MEKP) and room temperature accelerators may be used along with the binder 204 for curing the binder 204. High temperature setting catalysts such as benzoyl peroxide (BPO) may also be used for curing the binder 204. The filler is a fine powder, for example, aluminum trihydrate, calcium carbonate, quartz powder, or a combination of the compounds mentioned thereof, etc. The use of aluminum trihydrate as a filler makes the artificial stone laminate 200 disclosed herein fire resistant.

FIG. 3 exemplarily illustrates a deposited single layer 201 of particulates 202 of uniform size, which when vibrated touch one another adjacently in a horizontal plane. A layer of reinforcing fibers 203 is placed on the single layer 201 of particulates 202. The vibration of the particulates 202 causes the particulates 202 to touch one another adjacently in a horizontal plane.

FIG. 4 illustrates a method of manufacturing an artificial stone laminate 200. The method disclosed herein comprises the following steps. A single layer 201 of particulates 202 of uniform size is spread 401 on a release surface. The single layer 201 of particulates 202 on the release surface is vibrated 402. The vibration of the single layer 201 of particulates 202 causes the particulates 202 to pack closely, touch one another adjacently in a horizontal plane, and achieve high surface coverage as exemplarily illustrated in FIG. 3. A layer of reinforcing fibers 203 is placed 403 on the single layer 201 of particulates 202. A binder 204 is deposited 404 on the layer of reinforcing fibers 203. In an embodiment, the binder 204 can be deposited on the top single layer 201 of particulates 202 before the placement of the layer of reinforcing fibers 203. The binder 204 fills gaps between the particulates 202 and bonds the reinforcing fibers 203 to the particulates 202. The binder 204 may be deposited on the single layer 201 of particulates 202, for example, by one of the processes of resin transfer molding, tape casting, spraying, etc. The same binder 204 is used for both the top single layer 201 of particulates 202 and the rear layer of reinforcing fibers 203. The top single layer 201 of the particulates 202 and the rear layer of reinforcing fibers 203 are cast with the binder matrix 204 in situ resulting in the binder 204 matrix being continuous between the two layers 201 and 203. When the binder 204 cures, the surface of the single layer 201 of the particulates 202 is polished 405 until the substantially largest sectional area of the particulates 202 is exposed. Furthermore, the method disclosed herein comprises application of vacuum and pressure to the deposited binder 204, the single layer 201 of particulates 202, and the layer of reinforcing fibers 203, for example, during and/or after the deposition of the binder 204. The application of vacuum and/or pressure eliminates formation of air bubbles in the artificial stone laminate 200. The surface of the single layer 201 of particulates 202 is modified chemically for improved adhesion with the binder 204.

Decorative material may be embedded within the single layer 201 of particulates 202, for example, a single layer of quartz particulates. The decorative material comprises, for example, one or more of ornamental glass, quartz composite, semiprecious stone, metal art, colored quartz, glass or stone jewelry, etc. The decorative material is placed on a release surface, for example, on a Teflon® release sheet. The decorative material, for example, large quartz particulates 202 are deposited on the Teflon® release sheet. The large quartz particulates 202 may be treated with an organofunctional coupling agent for better adhesion between the large quartz particulates 202, and the binder 204 and the reinforcing fibers 203. The binder 204 is, for example, a polyester resin. The organofunctional coupling agent is, for example, an organofunctional silane. The release surface is vibrated whereby the large quartz particulates 202 are packed closely and achieve high surface coverage. The binder 204, for example, the polyester resin is deposited with a high concentration of solid filler. The binder 204 fills the gaps between the large quartz particulates 202. A layer of reinforcing fibers 203 is placed on the single layer 201 of large quartz particulates 202, wherein the binder 204 bonds the reinforcing fibers 203 to the single layer 201 of large quartz particulates 202. The surface of the single layer 201 of large quartz particulates 202 is polished along with the decorative work after the binder 204 cures, thereby exposing a large area of the large quartz particulates 202 on the surface of the artificial stone laminate 200.

The release surface is, for example, silicon rubber sheets, Teflon® of DuPont, mylar sheets, etc. The release surface may also be treated with release coatings, for example, polyvinyl alcohol or silicone sprays. In the artificial stone laminate 200 disclosed herein, some or the entire large quartz particulates 202 may be substituted with glass or ceramic particulates.

The percentage of the exposed top flat surface section area 202a of the particulates 202, when compared to the binder 204 matrix is very high, for example, greater than 80%. Such a high coverage of area of polished quartz particulates 202 results in a surface with scratch resistance and improved aesthetic appeal resulting from the transparency and visual depth of the large quartz particulates 202. The artificial stone laminate 200 disclosed herein is thin, flexible, and lightweight and is used as an architectural surfacing material. Examples of the application of the artificial stone laminate 200 disclosed herein include the surfacing of kitchen countertops, wall claddings, doors, tabletops, wardrobes, shelves, work-tops, counters, wall linings, column claddings, storage units, lift linings, store fittings, displays, vanity units, cubicles, check out desks, office partitions, and other home and office furniture.

The following example illustrates a method of manufacturing and the composition of an artificial stone laminate 200. A mix of particulates 202 of substantially a single size with the size of the mix of the particulates 202 ranging between 1.4 mm to 1.6 mm is deposited on a release surface, for example, a silicone rubber sheet of size 4 ft×8 ft placed on a metal work bench. The particulates 202 comprise 80% transparent quartz, 19% colored glass chips, and 1% aluminum coated glass chips. The aluminum coated glass chips provide a reflective shine to the artificial stone laminate 200. A single layer 201 of particulates 202 is deposited on the silicone rubber sheet placed on the metal work bench and the metal work bench is gently vibrated with an asymmetrically loaded shaft of a motor until the particulates 202 are packed together, and touch one another adjacently. Vertical overlap of the particulates 202 is avoided. The vertical overlap of the particulates 202 would undesirably result in a thicker and uneven section. A binder 204 comprising 75% isothalic neo pentyl glycol polyester resin, 20% styrene, 3% black pigment, 2% methyl ethyl ketone peroxide (MEKP) catalyst, and 0.2% dimethyl aniline (DMA) is deposited on the particulates 202 by either spraying or resin transfer molding. A layer of reinforcing fibers 203, for example, chopped strand matt of density 900 grams per square meter is placed on the single layer 201 of particulates 202. Vacuum is applied to the deposited binder 204, the single layer 201 of particulates 202, and the layer of reinforcing fibers 203 after the deposition of the binder 204, for example, by enveloping the particulates 202, the binder 204, and the reinforcing fibers 203 in a vacuum bag. After the mix cures, the cured composite is polished using diamond polishing bricks, until the substantially largest area of the particulates 202 is exposed. This results in an artificial stone laminate 200 of an approximate thickness of 1.5 mm.

The foregoing examples have been provided merely for the purpose of explanation and are in no way to be construed as limiting of the invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. An artificial stone laminate, comprising:
a top single layer of particulates, wherein said particulates are of substantially a single size, wherein each of said particulates has an exposed top flat surface section area, wherein said exposed top flat surface section area of each of said particulates is substantially the largest sectional area that can be exposed in said particulates;
a rear layer of reinforcing fibers backing said particulates; and
a binder bonding said particulates and said reinforcing fibers.

2. The artificial stone laminate of claim 1, wherein size deviation from said single size of said particulates is restricted to plus or minus 40%.

3. The artificial stone laminate of claim 1, wherein said single size of said particulates is chosen between 0.5 mm and 3 mm.

4. The artificial stone laminate of claim 1, wherein said binder is a polyester resin with a filler.

5. The artificial stone laminate of claim 1, wherein said binder is an acrylic resin.

6. The artificial stone laminate of claim 1, wherein said reinforcing fibers comprise glass fibers.

7. The artificial stone laminate of claim 1, wherein said rear layer of said reinforcing fibers is a knitted glass fiber yarn.

8. The artificial stone laminate of claim 1, wherein said particulates are quartz particulates.

9. The artificial stone laminate of claim 1, wherein said particulates are one or more of a combination of quartz particulates, metal pieces, and transparent particulates coated with metal and colored glass.

10. A method of manufacturing an artificial stone laminate, comprising:
spreading a single layer of particulates of uniform size on a release surface;
vibrating said single layer of particulates, wherein said vibration of said single layer of particulates causes said particulates to be packed closely, to touch one another adjacently in a horizontal plane, and to achieve high surface coverage;
placing a layer of reinforcing fibers on said single layer of particulates;
depositing a binder on said layer of reinforcing fibers, wherein said binder fills gaps between said particulates and bonds said reinforcing fibers to said particulates; and
polishing a surface of said single layer of said particulates until the substantially largest sectional area of said particulates is exposed.

11. The method of claim 10, further comprising applying vacuum and pressure to said deposited binder, said single layer of particulates, and said layer of reinforcing fibers during and/or after said deposition of said binder.

12. The method of claim 10, wherein said surface of said single layer of said particulates is modified chemically for improved adhesion with said binder.
